(19) United States
(12) Patent Application Publication
(10) Pub. No.: US 2014/0307026 A1
(43) Pub. Date: Oct. 16, 2014

(54) Printer Inkjet Head Cleaning System for Waste Ink Collection and Inkjet Head Cleaning and Protection

(71) Applicant: GREAT COMPUTER CORPORATION, New Taipei City (TW)

(72) Inventors: Chen-Chien TSAI, New Taipei City (TW); Chia-Liang LU, New Taipei City (TW); Hui-Te YU, New Taipei City (TW)

(73) Assignee: GREAT COMPUTER CORPORATION, New Taipei City (TW)

(21) Appl. No.: 13/863,816

(22) Filed: Apr. 16, 2013

(51) Int. Cl. B41J 2/165

(52) U.S. Cl. CPC B41J 2/16541
USPC 347/33

(57) ABSTRACT

A printer inkjet head cleaning system for waste ink collection and inkjet head cleaning and protection comprises a frame, a pushing device and a cleaning device. An accommodating space is disposed inside the frame. A horizontal rail and an elevating rail are correspondingly disposed on two lateral sides of the frame respectively. A cover used for protecting an inkjet head is disposed on the pushing device. Two sides of the pushing device are movably coupled on the horizontal rails so that the pushing device can displace on the horizontal rails horizontally. A scraper is disposed on the cleaning device. Two sides of the cleaning device are movably coupled on the elevating rails. An end of the cleaning device is connected with the pushing device so that the cleaning device can displace on the elevating rails when the pushing device moves forward and backward.

### BACKGROUND OF THE INVENTION

1. Field of Invention

The present invention relates to a printer inkjet head cleaning system for waste ink collection and inkjet head cleaning and protection and more particularly to a simple structured, low cost and compact cleaning system by which a printer inkjet head can be maintained during both printing and standby.

2. Related Art

Printer has become a basis and essential peripheral for computer and printing industry. Printer can be used for printing documents, assignments and reports. The color inkjet technology has made possible using an inkjet printer to produce colors intended to present by inkjeting colors of different concentration on a same location by different ink color cartridges. Therefore, a printout with photo quality produced by printer has become a reality.

For the printing industry, it is a trend to print products by using inkjet printing technique. Diversified products with small quantity can be achieved speedily and timely by employing inkjet printer for printing. As a result, both work and time for halftone color separations can be saved, which is an advantage in the competitive market.

When a common printer inkjet head is used during printing and standby or idle, each of the inkjet heads has to be supplied with ink regularly. After a period of standby, in order to restore the best inkjet functions of each of the inkjet heads, the inkjet heads have to be cleaned. If the inkjet heads are not used for a longer period, they have to be protected and prevented from exposing to air. For achieving the three functions mentioned above, at least two mechanisms with at least two driving sources are required for an inkjet printer sold in the market. Besides the problems of complicated integrated structures and high costs, the inkjet printer size also needs to be enlarged for accommodating the structures, which will occupy more space for a user to place the printer.

### SUMMARY OF THE INVENTION

A primary objective of the present invention is to provide a printer inkjet head cleaning system for waste ink collection and inkjet head cleaning and protection during both printing and standby.

In order to achieve the above-mentioned objectives, a printer inkjet head cleaning system for waste ink collection and inkjet head cleaning and protection provided by the present invention for disposing on a printer comprises a frame, a pushing device and a cleaning device. An accommodating space is disposed inside the frame. A horizontal rail and an elevating rail are correspondingly disposed on two lateral sides of the frame respectively. A cover used for protecting an inkjet head is disposed on the pushing device. Two sides of the pushing device are movably coupled on the horizontal rails so that the pushing device can displace on the horizontal rails horizontally. At least one scraper is disposed on the cleaning device for cleaning the inkjet head. Two sides of the cleaning device are movably coupled on the elevating rails. An end of the cleaning device is connected with the pushing device so that the cleaning device can displace to the left and right as well as upwardly and downwardly on the elevating rails when the pushing device moves forward and backward, and the scraper on the cleaning device can scrape off the waste ink of the inkjet head when the cleaning device displaces.

When the printer inkjet head cleaning system for waste ink collection and inkjet head cleaning and protection of the present invention is embodied, the elevating rails are in a U shape for forming a displacement distance with high and low levels. The cleaning device can continuously displace to the left and right as well as upwardly and downwardly on the elevating rails.

When the printer inkjet head cleaning system for waste ink collection and inkjet head cleaning and protection of the present invention is embodied, the cleaning device comprises an ink collecting container. The scraper is disposed on a top portion of the ink collecting container. Wheels are disposed on two sides of the ink collecting container, the cleaning device can displace on the elevating rails after the wheels are coupled on the elevating rails. An ink discharging hole is disposed on the ink collecting container for discharging ink. The ink discharging hole can be connected to an externally connected waste ink collecting bottle; thereby, waste ink can be discharged from the ink collecting container by flowing naturally or by sucking out using a liquid pump. The cleaning device further comprises an ink collecting box coupled inside the accommodating space of the frame. The ink collecting box is used for receiving leaked ink under abnormal conditions (such as causing by ink leakage because the ink collecting container is damaged or abnormal ink leakage due to abnormal operations of the cleaning system) in order to prevent mechanical or electrical devices in the printer other than the cleaning system from being polluted by the ink.

When the printer inkjet head cleaning system for waste ink collection and inkjet head. cleaning and protection of the present invention is embodied, wheels are disposed on the two sides of the pushing device for coupling on the horizontal rails; thereby, the pushing device can displace on the horizontal rails horizontally.

When the printer inkjet head cleaning system for waste ink collection and inkjet head cleaning and protection of the present invention is embodied, the pushing device is controlled by a driving device to drive the cleaning device to move forward and backward. The driving device is a motor.

When the printer inkjet head cleaning system for waste ink collection and inkjet head cleaning and protection of the present invention is embodied, the cover is a soft rubber cover.

The present invention will become more fully understood by reference to the following detailed description thereof when read in conjunction with the attached drawings.

### BRIEF DESCRIPTION OF THE DRAWINGS

FIG. 1 is a perspective exploded view of a printer inkjet head cleaning system for waste ink collection and inkjet head cleaning and protection according to an embodiment of the disclosure;

FIG. 2 is a perspective view of the printer inkjet head cleaning system for waste ink collection and inkjet head cleaning and protection after being assembled according to the embodiment of the disclosure;

FIG. 3 is a side view of the printer inkjet head cleaning system for waste ink collection and inkjet head cleaning and protection after being assembled according to the embodiment of the disclosure; and

FIGS. 4A-4E and 5A-5B are side views of the printer inkjet head cleaning system for waste ink collection and inkjet head cleaning and protection in consecutive actions according to the embodiment of the disclosure.

### DETAILED DESCRIPTION OF THE INVENTION

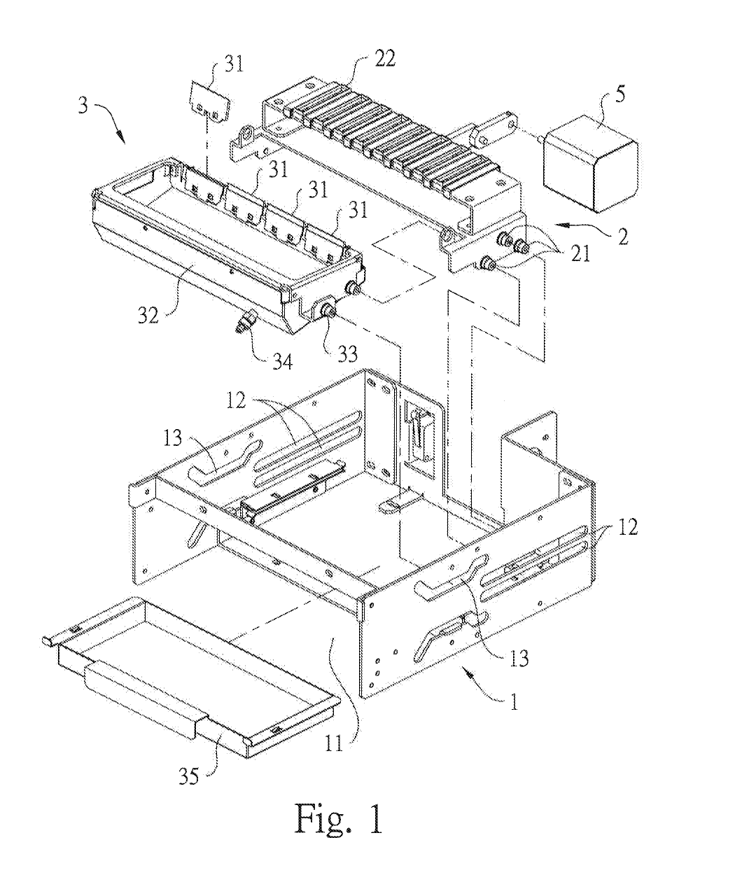

Please refer to FIG. 1, which shows a perspective exploded view of a printer inkjet head cleaning system for waste ink collection and inkjet head cleaning and protection according to an embodiment of the disclosure. The printer inkjet head cleaning system is provided for disposing on a printer. The printer inkjet head cleaning system is composed of a frame 1, a pushing device 2 and a cleaning device 3.

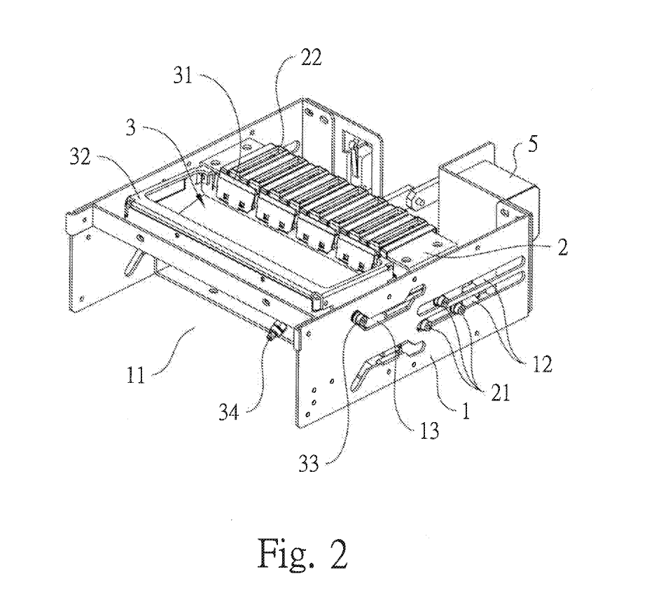

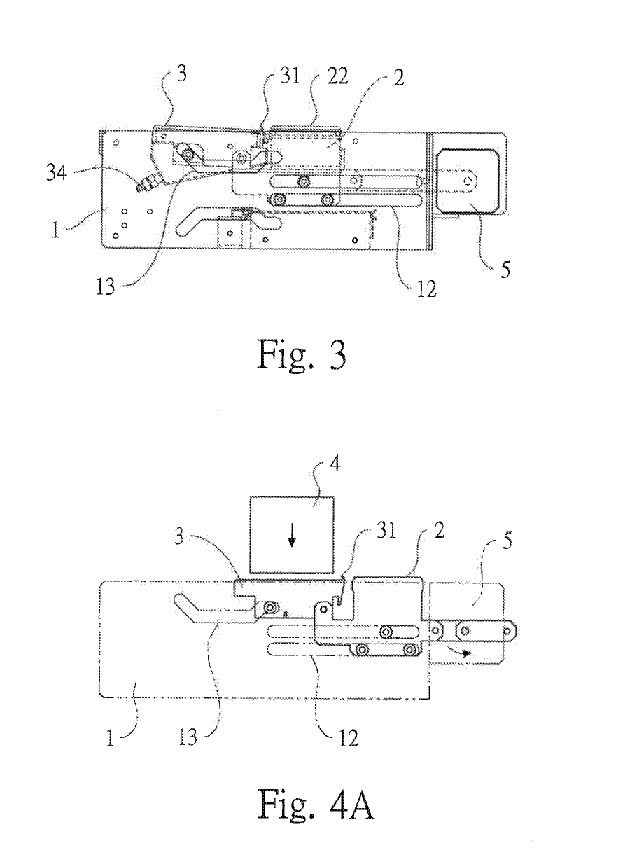

Please refer to FIGS. 1 to 4A. An accommodating space 11 is disposed inside the frame 1. A horizontal rail 12 and an elevating rail 13 are correspondingly disposed on two lateral sides of the frame 1 respectively.

Wheels 21 are disposed on two sides of the pushing device 2 for coupling on the horizontal rails 12 so that the pushing device 2 can displace on the horizontal rails 12 horizontally. A cover 22 used for protecting an inkjet head 4 is disposed on a location of the pushing device 2 corresponding to the inkjet head 4. The cover 22 is, for example, a soft rubber cover.

At least one scraper 31 is disposed on the cleaning device 3 for cleaning the inkjet head 4. Two sides of the cleaning device 3 are movably coupled on the elevating rails 13. When the printer inkjet head cleaning system is embodied, the elevating rails 13 are in a U shape for forming a displacement distance with high and low levels. Thereby, the cleaning device 3 can continuously displace to the left and right as well as upwardly and downwardly on the elevating rails 13. An end of the cleaning device 3 is connected with the pushing device 2 so that the cleaning device 3 can displace to the left and right as well as upwardly and downwardly on the elevating rails 13 when the pushing device 2 moves forward and backward, and the scraper 31 on the cleaning device 3 can scrape off the waste ink of the inkjet head 4 when the cleaning device 3 displaces.

Furthermore, the pushing device 2 is controlled by a driving device 5 to drive the cleaning device 3 to move forward and backward. The driving device 5 is, for example, a motor.

Additionally, the cleaning device 3 comprises an ink collecting container 32. The scraper 31 is disposed on a top portion of the ink collecting container 32. Wheels 33 are disposed on two sides of the ink collecting container 32, the cleaning device 3 can displace on the elevating rails 13 after the wheels 33 are coupled on the elevating rails 13. An ink discharging hole 34 is disposed on the ink collecting container 32 for discharging ink. The ink discharging hole 34 can be connected to an externally connected waste ink collecting bottle; thereby, waste ink can be discharged from the ink collecting container 32 by flowing naturally or by sucking out using a liquid pump. The cleaning device 3 further comprises an ink collecting box 35 coupled inside the accommodating space 11 of the frame 1. The ink collecting box 35 is used for receiving waste ink discharged from the ink discharging hole 34 of the ink collecting container 32.

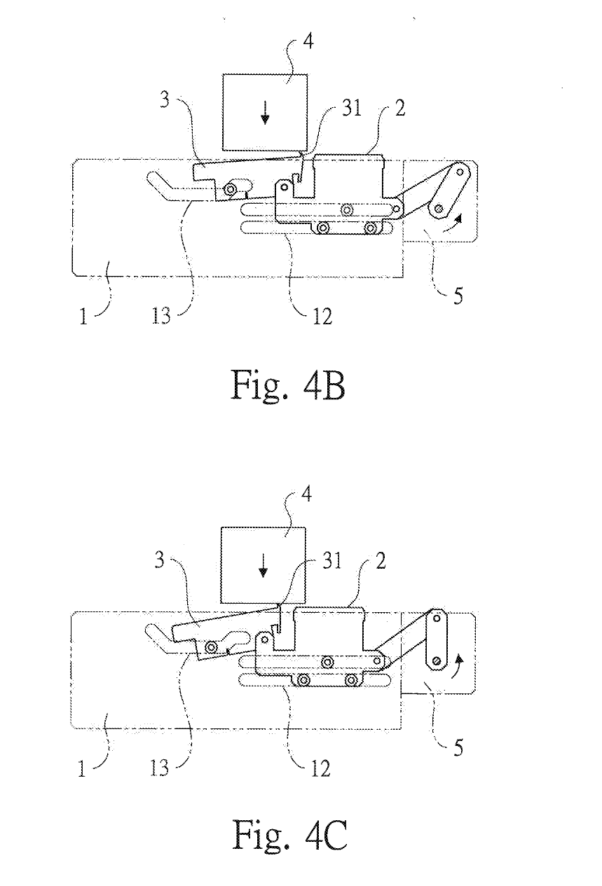

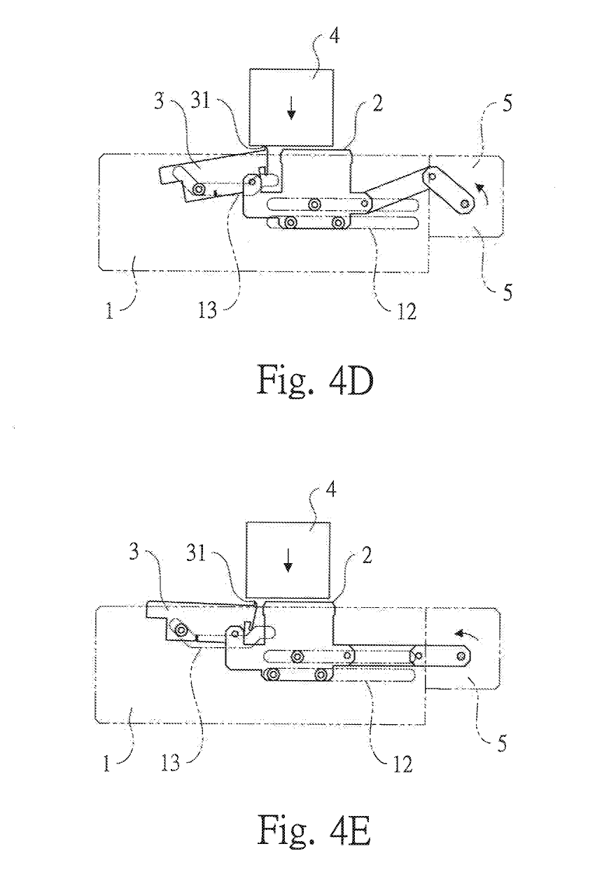

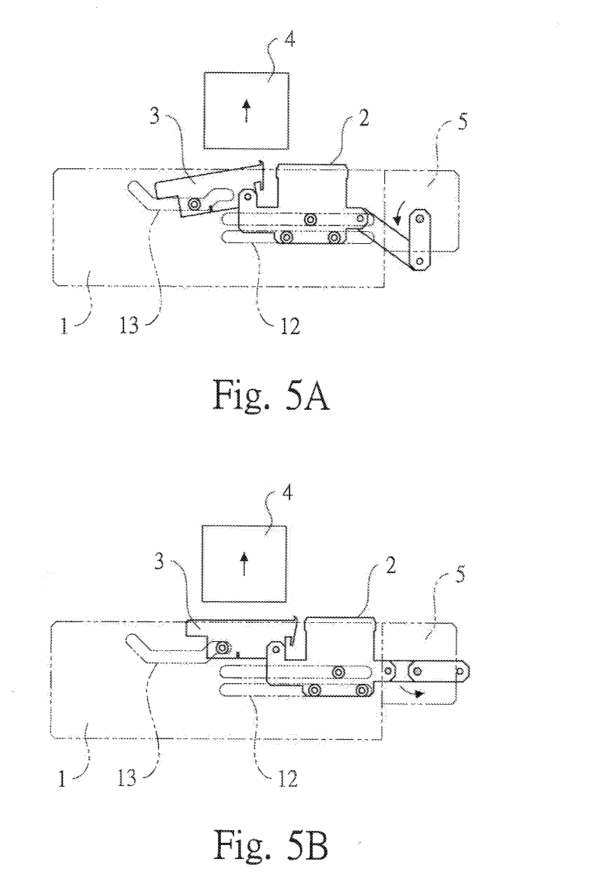

Therefore, as shown in an embodiment of the printer inkjet head cleaning system in FIGS. 4A to 5B, when the inkjet head 4 is descended above the cleaning device 3, the user can turn on the driving device 5 to control the pushing device 2 to move forward on the horizontal rails 12. Thereby, the cleaning device 3 is pushed by the pushing device 2 to move forward on the elevating rails 13. When the cleaning device 3 moves forward on the elevating rails 13, the scraper 31 on the cleaning device 3 can scrape off waste ink of the inkjet head 4 from one end of the inkjet head 4 along the way the cleaning device 3 moves. The waste ink being scraped off will flow into the ink collecting container 32 along the scraper 31, and then flow into the ink collecting box 35 through the ink discharging hole 34 of the ink collecting container 32, which will be collected for further disposal.

When the inkjet head 4 moves upward after the cleaning process is finished, the pushing device 2 will be controlled by the driving device 5 again to move backward on the horizontal rails 12. The cleaning device 3 is driven by the pushing device 2 to move backward to the original position on the elevating rails 13 and waits for the next cleaning. Furthermore, after the printing is finished by the inkjet head 4 or cleaning is finished for the inkjet head 4, the inkjet head 4 is displaced to locate above the pushing device 2. After the inkjet head 4 is descended, the soft rubber made cover 22 is used for covering a nozzle of the inkjet head 4 in order to protect the inkjet head 4 and prevent the ink from getting dried up due to exposure in air.

Thereby, based on the above mentioned designs of the prevent invention, the nozzle of the inkjet head 4 can be restored to the best inkjeting conditions by the cleaning of the cleaning device 3 during the printing process. The ink collecting structures designed for the cleaning device 3 can be used for collecting the waste ink scraped off by the scraper 31 effectively. After the printing is finished by the inkjet head 4 or during a longer period of not using the inkjet head 4, the inkjet head 4 can be protected and prevented from exposing in air by the cover 22.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A printer inkjet head cleaning system for waste ink collection and inkjet head cleaning and protection for disposing on a printer, comprising:
a frame, an accommodating space being disposed inside the frame, a horizontal rail and an elevating rail being correspondingly disposed on two lateral sides of the frame respectively;
a pushing device, two sides of the pushing device being movably coupled on the horizontal rails so that the pushing device displacing on the horizontal rails horizontally, a cover used for protecting an inkjet head being disposed on a location of the pushing device corresponding to the inkjet head; and
a cleaning device, at least one scraper being disposed on the cleaning device for cleaning the inkjet head, two sides of the cleaning device being movably coupled on the elevating rails, an end of the cleaning device being connected with the pushing device so that the cleaning device displacing to the left and right as well as upwardly and downwardly on the elevating rails when the pushing device moving forward and backward, and the scraper on the cleaning device scraping off waste ink of the inkjet head when the cleaning device displacing.

2. The printer inkjet head cleaning system for waste ink collection and inkjet head cleaning and protection as claimed in claim 1, wherein the elevating rails are in a U shape for forming a displacement distance with high and low levels, so that the cleaning device can continuously displace to the left and right as well as upwardly and downwardly on the elevating rails.

3. The printer inkjet head cleaning system for waste ink collection and inkjet head cleaning and protection as claimed in claim 1, wherein the cleaning device comprises an ink collecting container, the scraper is disposed on a top portion of the ink collecting container, wheels are disposed on two sides of the ink collecting container, the cleaning device can displace on the elevating rails after the wheels are coupled on the elevating rails.

4. The printer inkjet head cleaning system for waste ink collection and inkjet head cleaning and protection as claimed in claim 3, wherein an ink discharging hole is disposed on the ink collecting container for discharging ink.

5. The printer inkjet head cleaning system for waste ink collection and inkjet head cleaning and protection as claimed in claim 4, wherein the cleaning device further comprises an ink collecting box coupled inside the accommodating space of the frame for receiving waste ink discharged from the ink discharging hole of the ink collecting container.

6. The printer inkjet head cleaning system for waste ink collection and inkjet head cleaning and protection as claimed in claim 1, wherein wheels are disposed on the two sides of the pushing device for coupling on the horizontal rails to enable the pushing device to displace on the horizontal rails horizontally.

7. The printer inkjet head cleaning system for waste ink collection and inkjet head cleaning and protection as claimed in claim 1, wherein the pushing device is controlled by a driving device to drive the cleaning device to move forward and backward.

8. The printer inkjet head cleaning system for waste ink collection and inkjet head cleaning and protection as claimed in claim 1, wherein the driving device is a motor.

9. The printer inkjet head cleaning system for waste ink collection and inkjet head cleaning and protection as claimed in claim 1, wherein the cover is a soft rubber cover.
